(19) United States
(12) Patent Application Publication
(10) Pub. No.: US 2008/0046373 A1
(43) Pub. Date: Feb. 21, 2008

(54) APPARATUS AND METHOD FOR MANAGING THE RIGHT OF CONTENT IN A MOBILE COMMUNICATION SYSTEM

(75) Inventor: Jin-Gang KIM, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/782,325

(22) Filed: Jul. 24, 2007

(30) Foreign Application Priority Data
Aug. 18, 2006 (KR) 2006-0078136

(51) Int. Cl. G06Q 10/00

(52) U.S. Cl. 705/51; 705/1

(57) ABSTRACT

An apparatus and method for managing the rights of content in a mobile communication are provided. The apparatus includes a conversion unit for converting a Digital Rights Management (DRM) format using a Rights Object (RO); a user database for storing information in DRM formats supported by registered users' terminals; a communication unit for receiving the RO from an RO issuing server or a content server, and transmitting/receiving a message to/from a terminal; and a control unit for requesting the RO of the received content to the RO issuing server or the content server, for controlling the conversion unit to convert the received content into a DRM format, and for controlling the communication unit to transmit a message containing the converted content to the receive terminal.

### PRIORITY

This application claims priority under 35 U.S.C. §119(a) to a Korean Patent Application filed in the Korean Intellectual Property Office on Aug. 18, 2006 and assigned Serial No. 2006-78136, the contents of which are incorporated herein by reference.

### BACKGROUND OF THE INVENTION

1. Field of the Invention

The present invention relates generally to an apparatus and method for managing the right of content in a mobile communication system, and in particular, to an apparatus and method, when a Multimedia Message Service (MMS) server of the mobile communication system receives a message containing content from a transmit (TX) terminal, the received content is converted into a Digital Rights Management (DRM) format supported by a receive (RX) terminal and, thereafter, the converted content is transmitted to the RX terminal over a message.

2. Description of the Related Art

DRM has been extensively researched and is being applied to all forms of commercial services. In general, DRM is a technology for protecting digital content from being illegal copied and distributed.

Today, technological efforts have been repeatedly made to protect digital content, focusing mainly on protection against unauthorized access to the content. For example, digital content is only accessible to users who have paid for the content, but not to users who have not paid. However, digital content can be re-used, processed, copied, and distributed easily given the inherent characteristics of digital data. Accordingly, even unauthorized users can use digital content when authorized users copy or distribute the digital content without permission.

To solve this problem, DRM technology encrypts the digital content before its distribution, so that a license called a Rights Object (RO) is required before any use of the encrypted digital content can take place.

FIG. 1 illustrates a configuration of a conventional mobile communication system providing digital content. In FIG. 1, terminals 122, 124, and 126 can acquire desired digital content from content servers 112, 114, and 116. Because the digital content provided from the content servers 112, 114, and 116 is the encrypted digital content (content), an RO is required to use the content.

The terminals 122, 124, and 126 can acquire the RO containing an authorization to deliver the content from a RO issuing server 130 by paying for the content. The authorization contained in the RO may be a content-encryption key that can decrypt the content. The RO issuing server 130 reports the RO issuing details to the content servers 112, 114, and 116. In some cases, the RO issuing server and the content servers 112, 114, and 116 may be configured with a single server. The terminals 122, 124, and 126 can access the content based on the acquired RO.

Moreover, the content received by one terminal may or may not be forwarded to other terminals. For instance, when a forward-lock setting is set, the content cannot be forwarded to another terminal. Conversely, when no forward-lock setting is set, the content can be freely copied and distributed to other terminals. However, the RO can limit the reuse or copy of content by containing information about allowed use-count and/or terms relating to content usage, or even information about allowed copy count of the RO. As a result, digital content can be effectively protected using the latest DRM technology.

Examples of DRM formats include Microsoft's Window Media DRM (WMDRM), Apple's FairPlay DRM, Open Mobile Alliance's OMA DRM, and Real Networks' Helix DRM. Most of today's mobile terminals generally support one of these DRM formats. In this case, when a mobile terminal receives content encrypted in an unsupported DRM format, the terminal cannot deliver the received content even though the terminal has acquired a legitimate RO to receive the content.

Generally, problems do not occur in digital content delivery when the content server provides content that's encrypted in a DRM format supported by the receiving terminal. However, when a message containing content (content message) is transmitted between terminals, in which each terminal has a different DRM format, the terminal is prohibited from delivering the received content even when the forward lock setting is not set.

### SUMMARY OF THE INVENTION

An aspect of the present invention is to substantially solve at least the above problems and/or disadvantages and to provide at least the advantages below. Accordingly, one aspect of the present invention is to provide an apparatus and method for managing the right of content in a mobile communication system.

Another aspect of the present invention is to provide an apparatus and method for managing the right of content when content is transmitted between terminals, in which each terminal has a different DRM format.

Still another aspect of the present invention is to provide an apparatus and method for managing the right of content in a mobile communication system, in which, when an MMS server receives a content message from a TX terminal, the received content is converted into a DRM format supported by a RX terminal and a message containing the converted content is then transmitted to the RX terminal.

According to one aspect of the present invention, there is provided an apparatus for managing the right of content in a mobile communication system. The apparatus includes a conversion unit for converting a DRM format using a RO; a user database for storing information about DRM formats supported by registered users' terminals; a communication unit for receiving the RO from a RO issuing server or a content server, and for transmitting/receiving a message to/from a terminal; and a control unit for, when a message containing a content encrypted in a DRM format unsupported by an RX terminal is received, requesting the RO of the received content to the RO issuing server or the content server, and for controlling the conversion unit to convert the the received content into a DRM format supported by the RX terminal, and for controlling the communication unit to transmit a message containing the converted content to the RX terminal.

According to another aspect of the present invention, there is provided a method for managing the right of content in a mobile communication system. The method includes receiving a content message; searching from a user database a DRM format supported by an RX terminal; determining if a DRM format of a content contained in the received content message is supported by the RX terminal; requesting a RO to a RO issuing server or a content server when the DRM format of the received content is unsupported by the RX terminal; receiving the RO from the RO issuing server or the content server; converting the received content into a DRM format supported by the RX terminal using the RO; and transmitting a message containing the converted content to the RX terminal.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a configuration of a conventional mobile communication system for providing digital content;

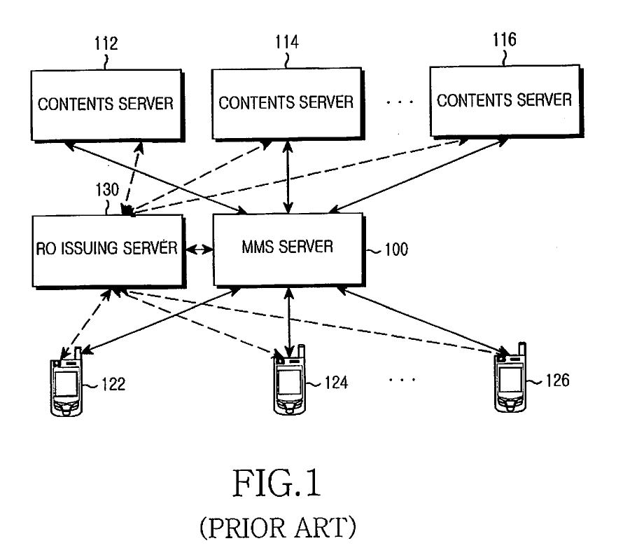

FIG. 2 illustrates a configuration of a message server for managing the right of content according to the present invention; and

FIG. 3 is a flow diagram illustrating a process for managing the right of content in the message server of FIG. 2 according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for managing the right of content in a mobile communication system. In cases where a TX terminal and an RX terminal have a different DRM format, when an MMS server receives a content message from the TX terminal, the MMS converts the received content into a DRM format supported by the RX terminal and transmits a message containing the converted content to the RX terminal.

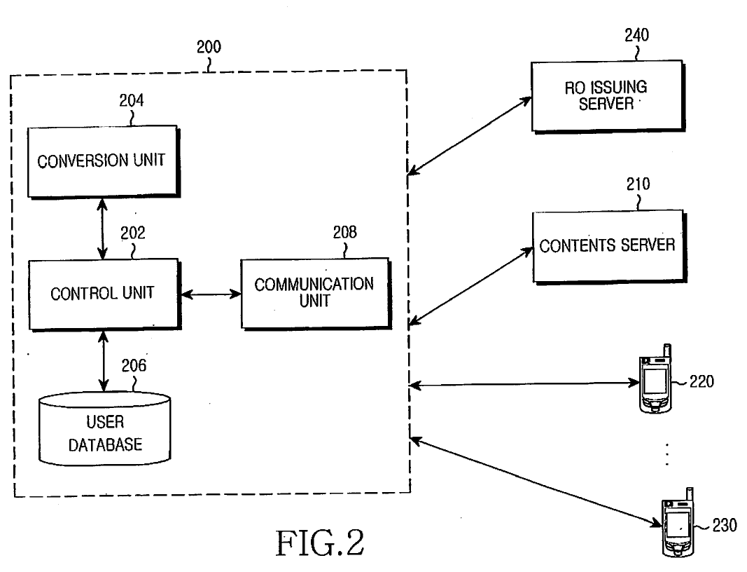

FIG. 2 illustrates a message server for managing the right of content according to the present invention.

In FIG. 2, the message server 200 includes a control unit 202, a conversion unit 204, a user database 206, and a communication unit 208.

Under the control of the control unit 202, the conversion unit 204 decrypts a content contained in a received content message using a RO received from a RO issuing server 240, and encrypts the content in a DRM format supported by a RX terminal. Consequently, the conversion unit 204 converts the DRM format of the content.

The user database 206 stores the information concerning a DRM format supported by the users' terminals registered in the message server 200.

The communication unit 208 communicates with a content server 210, the RO issuing server 240, and terminals 220 and 230 through various communication media. Specifically, the communication unit 208 transmits/receives the content message to/from the terminals 220 and 230, receives the RO from the RO issuing server 240 or the content server 210, and transmits the information about DRM format conversion and message transmission to the content server 210.

Upon receipt of a message containing a content encrypted in DRM format unsupported by the RX terminal, the control unit 202 requests the RO of the received content to the RO issuing server 240 or the content server 210. The control unit 202 controls the conversion unit 204 to convert the received content into a DRM format supported by the RX terminal, and controls the communication unit 208 to transmit the converted content to the RX terminal over a message.

In addition, the RO issuing server 240 and the content server 210 may be configured with a single server.

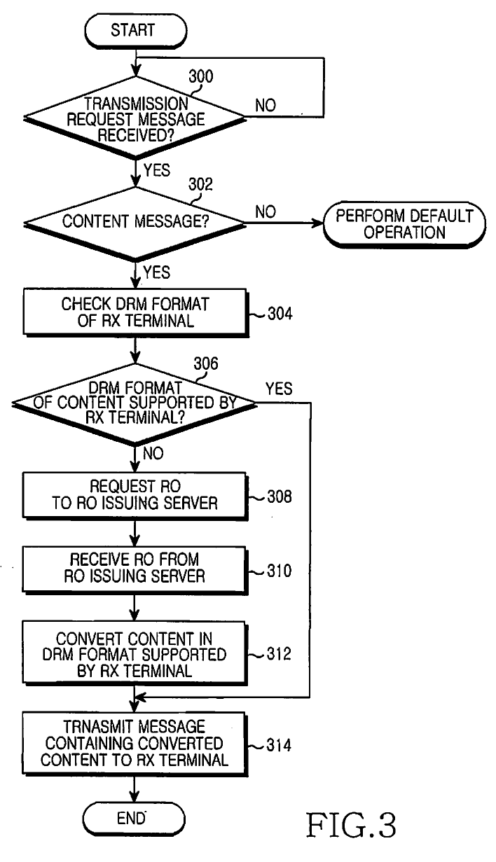

A method for managing the right of content according to the present invention will be described with reference to FIG. 3.

FIG. 3 is a flow diagram illustrating a process for managing the right of content in the message server of FIG. 2 according to the present invention.

In FIG. 3, when the message server receives a transmission request message in step 300, the message server checks if the received message is a content message in step 302. The message server performs a default operation when the received message is not the content message.

In step 304, the message server searches from the user database the information about a DRM format supported by an RX terminal when the received message is the content message. In step 306, the message server then determines if the RX terminal supports the DRM format of the content contained in the received message. When the RX terminal supports the DRM format of the content, the message server transmits the received message to the RX terminal without conversion of the DRM format in step 314.

In step 308, the message server requests a RO to the RO issuing server or the content server when the RX terminal does not support the DRM format of the content. In step 310, the message server receives the RO from the RO issuing server or the content server. In step 312, the message server converts the received content into a DRM format supported by the RX terminal using the received RO. In step 314, the message server transmits a message containing the converted content to the RX terminal.

The conversion of the DRM format in step 312 includes: decrypting the received content using the received RO; and encrypting the decrypted content in a DRM format supported by the RX terminal.

As described above, when the MMS server of the mobile communication system receives the content message from the TX terminal, the MMS server converts the content into a DRM format supported by the RX terminal, and transmits the converted content to the RX terminal over a message. Accordingly, the message containing the content can be transmitted between the terminals each having a different DRM format.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for managing the right of content in a mobile communication system, the apparatus comprising:
a conversion unit for converting a Digital Rights Management (DRM) format using a Rights Object (RO);
a user database for storing information about DRM formats supported by registered users' terminals;
a communication unit for receiving the RO from a RO issuing server or a content server, and transmitting/receiving a message to/from a terminal; and
a control unit for, when a message containing a content encrypted in a DRM format unsupported by a receive terminal is received, requesting the RO of the received content to the RO issuing server or the content server, and for controlling the conversion unit to convert the received content into a DRM format supported by the receive terminal, and for controlling the communication unit to transmit a message containing the converted content to the receive terminal.

2. The apparatus of claim 1, wherein the conversion unit decrypts the received content using the received RO, and encrypts the decrypted content in the DRM format supported by the receive terminal.

3. The apparatus of claim 1, wherein upon receipt of a message containing a content encrypted in the DRM format supported by the receive terminal, the control unit transmits the received message to the receive terminal without the conversion of the DRM format.

4. The apparatus of claim 1, wherein the RO issuing server and the content server are configured with a single server, and a RO is transmitted when the RO is requested from the apparatus for managing the right of content.

5. A method for managing the right of content in a mobile communication system, the method comprising:
receiving a content message;
searching from a user database a Digital Rights Management (DRM) format supported by a receive terminal;
determining if a DRM format of a content contained in the received content message is supported by the receive terminal;
requesting a Rights Object (RO) to a RO issuing server or a content server when the DRM format of the received content is unsupported by the receive terminal;
receiving the RO from the RO issuing server or the content server;
converting the received content into a DRM format supported by the receive terminal using the RO; and
transmitting a message containing the converted content to the receive terminal.

6. The method of claim 5, wherein converting the received content comprises:
decrypting the DRM format of the received content using the received RO; and
encrypting the decrypted content in the DRM format supported by the receive terminal.

7. The method of claim 5, wherein the received content message is transmitted to the receive terminal without the conversion of the DRM format when the DRM format of the received content is supported by the RX terminal.

8. An apparatus for managing the right of content in a message server, the apparatus comprising:
a conversion unit for converting a Digital Rights Management (DRM) format using a Rights Object (RO);
a user database for storing information about DRM formats supported by registered users' terminals;
a communication unit for receiving the RO from a RO issuing server or a content server, and transmitting/receiving a message to/from a terminal; and
a control unit for, when a message containing a content encrypted in a DRM format unsupported by a receive terminal is received, requesting the RO of the received content to the RO issuing server or the content server, and for controlling the conversion unit to convert the received content into a DRM format supported by the receive terminal, and for controlling the communication unit to transmit a message containing the converted content to the receive terminal.

9. The apparatus of claim 8, wherein the conversion unit decrypts the received content using the received RO, and encrypts the decrypted content in the DRM format supported by the receive terminal.

10. The apparatus of claim 8, wherein upon receipt of a message containing a content encrypted in the DRM format supported by the receive terminal, the control unit transmits the received message to the receive terminal without the conversion of the DRM format.

11. The apparatus of claim 8, wherein the RO issuing server and the content server are configured with a single server, and a RO is transmitted when the RO is requested from the apparatus for managing the right of content.

12. A method for managing the right of content in a message server, the method comprising:
receiving a content message;
searching from a user database a Digital Rights Management (DRM) format supported by a receive terminal;
determining if a DRM format of a content contained in the received content message is supported by the receive terminal;
requesting a Rights Object (RO) to a RO issuing server or a content server when the DRM format of the received content is unsupported by the receive terminal;
receiving the RO from the RO issuing server or the content server;
converting the received content into a DRM format supported by the receive terminal using the RO; and
transmitting a message containing the converted content to the receive terminal.

13. The method of claim 12, wherein the step of converting the received content comprises:
decrypting the DRM format of the received content using the received RO; and
encrypting the decrypted content in the DRM format supported by the receive terminal.

14. The method of claim 12, wherein the received content message is transmitted to the receive terminal without the conversion of the DRM format when the DRM format of the received content is supported by the RX terminal.

15. An apparatus for managing the right of content in a mobile communication system, the apparatus comprising:
means for receiving a content message;
means for searching from a user database a Digital Rights Management (DRM) format supported by a receive terminal;
means for determining if a DRM format of a content contained in the received content message is supported by the receive terminal;
means for requesting a Rights Object (RO) to a RO issuing server or a content server;
means for receiving the RO from the RO issuing server or the content server;
means for converting the received content into a DRM format supported by the receive terminal using the RO; and
means for transmitting a message containing the converted content to the receive terminal.

16. The apparatus of claim 15, wherein the means for converting the received content comprises:
means for decrypting the DRM format of the received content using the received RO; and
means for encrypting the decrypted content in the DRM format supported by the receive terminal.

17. The apparatus of claim 15, further comprising, means for transmitting the received content message to the receive terminal without the conversion of the DRM format.

18. A computer-readable recording medium having recorded thereon a program for managing the right of content in a mobile communication system, comprising:
a first code segment, for receiving a content message;
a second code segment, for searching from a user database a Digital Rights Management (DRM) format supported by a receive terminal;
a third code segment, for determining if a DRM format of a content contained in the received content message is supported by the receive terminal;
a fourth code segment, for requesting a Rights Object (RO) to a RO issuing server or a content server;
a fifth code segment, for receiving the RO from the RO issuing server or the content server;
a sixth code segment, for converting the received content into a DRM format supported by the receive terminal using the RO; and
a seventh code segment, for transmitting a message containing the converted content to the receive terminal.
